(19) United States
(12) Patent Application Publication
(10) Pub. No.: US 2009/0183965 A1
(43) Pub. Date: Jul. 23, 2009

(54) MULTIPLATE CLUTCH

(75) Inventors: Wolfgang Reisser, Heimsheim (DE); Arne Kruger, Karlsruhe (DE); Thorsten Boger, Boblingen-Dagersheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/356,815

(22) Filed: Jan. 21, 2009

(30) Foreign Application Priority Data
Jan. 19, 2008 (DE) 10 2008 005 227.2

(51) Int. Cl. F16D 13/52; F16D 13/64

(52) U.S. Cl. 192/70.14; 29/274

(57) ABSTRACT

A multiplate clutch, in particular a starting clutch in a motor vehicle, has primary-side plates which are connected to a drive unit and secondary-side plates which are connected to a drivetrain, in particular to a transmission input. The primary-side and/or secondary-side plates are aligned, in each case with regard to their flatness deviations, with respect to one another, that is to say are arranged so as to be rotated relative to one another in the peripheral direction, such that at least the flatness deviations of adjacent plates do not abut against one another in the axial direction.

### CROSS REFERENCE TO RELATED APPLICATION

This application claims the priority, under 35 U.S.C. §119(e), of provisional application No. DE 10 2008 005 227.2, filed Jan. 19, 2008; the prior application is herewith incorporated by reference in its entirety.

### BACKGROUND OF THE INVENTION

### Field of the Invention

The present invention relates to a multiplate clutch, in particular a starting clutch for a motor vehicle, having primary-side plates to be connected to a drive unit and secondary-side plates to be connected to a drivetrain, in particular a transmission input. The invention also relates to a motor vehicle which is fitted with a multiplate clutch of said type.

Published, non-prosecuted German patent application DE 102 55 537 A1 discloses a generic multiplate clutch which is hydraulically actuated and which is configured as a starting clutch for automatic transmissions in motor vehicles. The multiplate clutch has a plurality of annular steel plates and lining plates which are placed together in series in an alternating fashion and which are connected in each case radially at the outside and radially at the inside in a rotationally locking manner to drive elements and which are supported at one side by an axially immovable support part and are acted upon at the other side by an axially movable actuating piston. Here, at least one annular, resiliently flexible disk is provided between the support part on the one hand and the actuating piston on the other hand, which disk is intended to bring about a more uniform transmission of torque and thereby improved damping properties of the multiplate clutch.

In general, during the production of multiplate clutches, there is always the problem that individual plates or a plurality of plates can, on account of flatness deviations, trigger torque fluctuations in the slipping clutch. The torque fluctuations are perceived as disturbing during starting, and manifest themselves as undesired variations in the vehicle acceleration, or vibrations in the vehicle.

### SUMMARY OF THE INVENTION

It is accordingly an object of the invention to provide a multiplate clutch that overcomes the above-mentioned disadvantages of the prior art devices of this general type, which embodiment is distinguished in particular by extremely small torque fluctuations.

With the foregoing and other objects in view there is provided, in accordance with the invention, a multiplate clutch. The multiplate clutch contains plates having flatness deviations. The plates include primary-side plates to be connected to a drive unit and secondary-side plates to be connected to a drivetrain. At least two of the primary-side and/or the secondary-side plates are aligned, in each case with regard to the flatness deviations, with respect to one another, that is to say are disposed so as to be rotated relative to one another in a peripheral direction, such that at least the flatness deviations of the in each case aligned and adjacent plates do not abut against one another in an axial direction.

The invention is based on the general concept of aligning the previously unsorted plates, or at least some of them, relative to one another, specifically in such a way that the flatness deviations of the aligned or rotated plates do not abut axially against one another in their local position, that is to say they are not arranged in the same way in the peripheral direction. Here, the multiplate clutch has primary-side plates which are connected to a drive unit, for example the engine of a motor vehicle, and secondary-side plates which are connected to a drivetrain, in particular to a transmission input. As a result of the alignment of the primary-side and/or secondary-side plates in each case with respect to their flatness deviations, it is possible to reliably prevent the flatness deviations abutting against one another in the axial direction and thereby being able to lead to the torque fluctuations which are perceived as disturbing.

The alignment of one or more plates takes place here during or before the assembly of the multiplate clutch, for which purpose the individual plates are precisely gauged with respect to their flatness. The plates themselves are substantially annular disks, with the flatness deviations being defined as deviations which project out of the disk plane. As a result of the gauging of the individual plates, in which the flatness deviations can be localized in a precise fashion, it is possible to align the individual plates relative to one another in the peripheral direction in such a way that, if flatness deviations are present, the flatness deviations do not come to rest against one another in the axial direction in an assembled plate pack. In this way, it is possible to create a multiplate clutch which does not have the typical starting vibration or clutch judder which is caused by torque fluctuations during starting, as a result of which in particular driving comfort can be considerably improved.

Alternatively, the plate pack may first be completed such that, in the completed state, one or more plates are rotated until the torque fluctuation of the entire plate pack is as low as possible or no longer exceeds a defined limit value. In this way, a previous precise measurement or documentation of the flatness deviations of all the plates is avoided. That is to say, it is not necessary to document the precise local position of the flatness deviation in the plates.

In a further advantageous embodiment of the solution according to the invention, the individual plates of a plate pack are aligned with respect to one another in such a way that the in each case maximum flatness deviations of individual plates are distributed substantially uniformly in the peripheral direction of the plate pack. Both the primary-side and also the secondary-side plates are conventionally combined in so-called plate packs which have for example five to six plates. Here, during the gauging of the individual plates, in each case the maximum flatness deviation is detected or measured and the plates of the respective plate pack are arranged such that, for example in the case of five plates per plate pack, the individual maximum flatness deviations are arranged so as to be rotated by approximately 72° with respect to one another. By an arrangement of this type, it is possible to obtain a particularly great reduction in the torque fluctuations which are perceived as disturbing, which is perceived as being extremely comfortable by a driver of the motor vehicle which is fitted with a multiplate clutch of this type.

It is self-evident that the features mentioned above and the features yet to be explained below can be used not only in the respectively specified combination but also in other combinations or individually without departing from the scope of the present invention.

Other features which are considered as characteristic for the invention are set forth in the appended claims.

Although the invention is illustrated and described herein as embodied in a multiplate clutch, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a total of six plates of a plate pack, with each plate having a flatness deviation illustrated in a highly exaggerated fashion and according to the invention; and

FIG. 2 is a diagrammatic, side view of the plate pack.

### DETAILED DESCRIPTION OF THE INVENTION

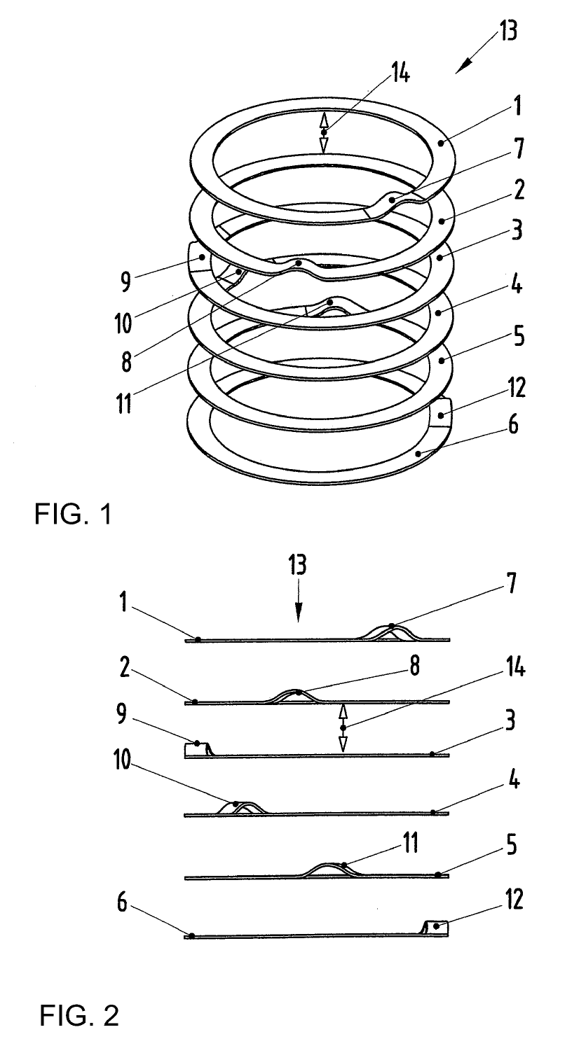

Referring now to the figures of the drawing in detail and first, particularly, to FIG. 1 thereof, there is shown individual plates 1 to 6 which have in each case one flatness deviation 7 to 12 which is illustrated in a highly exaggerated fashion. Here, it is of course also conceivable that, in contrast to FIG. 1, each plate 1 to 6 has not just one flatness deviation 7 to 12 but rather a plurality. Here, the plates 1 to 6 may be configured as so-called primary-side plates which are connected to a drive unit or as secondary-side plates which are connected to a drivetrain, in particular to a transmission input.

According to the invention, the individual plates 1 to 6 of a plate pack 13 are now aligned, in each case with regard to their flatness deviations 7 to 12, with respect to one another, that is to say are arranged so as to be rotated relative to one another in a peripheral direction, such that at least the flatness deviations 7 to 12 of adjacent plates, for example of plates 1 and 2, do not abut against one another in an axial direction 14. Here, it is of course also conceivable that not only the plates which are situated in each case adjacent to one another, for example the plates 1 and 2 or 3 and 4, but rather all the plates 1 to 6 of a plate pack 13 are arranged with regard to their flatness deviations 7 to 12 so as to be rotated relative to one another such that the flatness deviations 7 to 12 do not rest against one another, that is to say are not aligned, in the axial direction. This can be particularly clearly seen from FIG. 2.

The alignment of the individual plates 1 to 6 with regard to their flatness deviations 7 to 12 reduces in particular torque fluctuations which occur during starting and which are perceived by a driver of the motor vehicle as disturbing starting vibrations. The plates 1 to 6 have hitherto been installed in the plate pack 13 in an unsorted, that is to say non-aligned, fashion, such that it has been possible, in the worst case, for the flatness deviations of two adjacent plates, for example plates 1 and 2, to be arranged aligned with one another in the axial direction, and for this to lead to torque fluctuations which are perceived as uncomfortable. With the alignment according to the invention of the individual plates 1 to 6 with regard to their flatness deviations 7 to 12, the disturbing effect can preferably be eliminated completely, thereby making it possible to obtain a great increase in driving comfort.

Here, the plates 1 to 6 illustrated in FIGS. 1 and 2 may be embodied as primary-side plates or as secondary-side plates. The primary-side plates are conventionally embodied as so-called steel plates, while the secondary-side plates are embodied as so-called lining plates. A multiplate clutch which is fitted with plates 1 to 6 of the type offers the great advantage that it can be shifted under load and is of extremely compact construction. Furthermore, multiplate clutches of the type can be produced in a cost-effective manner. In so-called oil-lubricated (wet-running) multiplate clutches in particular, it is possible, with sufficient lubrication, for both the primary-side and the secondary-side plates 1 to 6 to be embodied as so-called steel plates and to have for example an alloy additive such as molybdenum. Conventionally, however, the secondary-side plates are often coated, as a result of which their friction coefficients are increased and the temperature resistance is improved and it is possible to obtain a smoother response behavior or a reduction in operating noise. Common friction or lining materials are for example paper or carbon fiber linings.

It is also conceivable for the multiplate clutch to be a constituent part of a so-called dual-clutch transmission which is composed of two automatic partial transmissions with in each case one clutch. Here, one partial transmission has the even gears while the other partial transmission has the odd gears. A reverse gear may be assigned either to the even or to the odd partial transmission depending on the transmission concept. Here, one peculiarity is in particular that both partial transmissions of the dual-clutch transmission act on a common transmission output or on a common differential.

To produce the multiplate clutch according to the invention, therefore, the individual plates 1 to 6 are first, with regard to their flatness deviations 7 to 12, precisely gauged and then aligned with respect to one another. Here, an alignment may for example also take place such that the in each case maximum flatness deviations 7 to 12 of individual plates 1 to 6 are distributed substantially uniformly in the peripheral direction of the plate pack 13. This permits a particularly free-moving multiplate clutch with low torque fluctuation.

Since the individual plates 1 to 6 conventionally have a plurality of flatness deviations 7 to 12, it is also possible for a special computer program to be provided which measures the individual flatness deviations 7 to 12 of the respective plates 1 to 6 and aligns the flatness deviations 7 to 12 with respect to one another such that only minimum torque fluctuations are to be expected during starting.

1. A multiplate clutch, comprising:
plates having flatness deviations, said plates including primary-side plates to be connected to a drive unit and secondary-side plates to be connected to a drivetrain, at least two of said primary-side and/or said secondary-side plates are aligned, in each case with regard to said flatness deviations, with respect to one another, that is to say are disposed so as to be rotated relative to one another in a peripheral direction, such that at least said flatness deviations of in each case aligned and adjacent said plates do not abut against one another in an axial direction.

2. The multiplate clutch according to claim 1, wherein said primary-side plates are steel plates.

3. The multiplate clutch according to claim 1, wherein said secondary-side plates are lining plates.

4. The multiplate clutch according to claim 1, wherein at least one of said primary-side plates and said secondary-side plates are in each case combined to form plate packs.

5. The multiplate clutch according to claim 1, wherein the multiplate clutch is a constituent part of a dual-clutch transmission.

6. The multiplate clutch according to claim 4, wherein individual ones of said plates of a plate pack are aligned with respect to one another such that in each case maximum flatness deviations of individual ones of said plates are distributed substantially uniformly in the peripheral direction of said plate pack.

7. The multiplate clutch according to claim 1, wherein:
the multiplate clutch is a starting clutch in a motor vehicle; and
the drivetrain is a transmission input.

8. A motor vehicle, comprising:
a drive unit;
a drivetrain; and
a multiplate clutch containing plates having flatness deviations, said plates including primary-side plates connected to said drive unit and secondary-side plates connected to said drivetrain, at least two of said primary-side and/or said secondary-side plates are aligned, in each case with regard to said flatness deviations, with respect to one another, that is to say are disposed so as to be rotated relative to one another in a peripheral direction, such that at least said flatness deviations of said in each case aligned and adjacent plates do not abut against one another in an axial direction.

9. A method for producing a multiplate clutch, which comprises the steps of:
providing plates having flatness deviations, the plates including primary-side plates to be connected to a drive unit and secondary-side plates to be connected to a drivetrain; and
aligning at least two of the primary-side plates and/or secondary-side plates, in each case with regard to the flatness deviations, with respect to one another, that is to say are disposed so as to be rotated relative to one another in a peripheral direction, such that at least the flatness deviations of the aligned and adjacent plates do not abut against one another in an axial direction.

10. The method according to claim 9, which further comprises first completing a plate pack of at least one of the primary-side plates and the secondary-side plates such that, in a completed state, at least one of the plates is rotated until a torque fluctuation of the plate pack is as low as possible or no longer exceeds a defined limit value.

11. The multiplate clutch according to claim 9, wherein:
the multiplate clutch is a starting clutch in a motor vehicle; and
the drivetrain is a transmission input.
